(19) United States
(12) Patent Application Publication
(10) Pub. No.: US 2005/0044025 A1
(43) Pub. Date: Feb. 24, 2005

(54) Method for customizing and producing products and services

(75) Inventors: Verigin R.Y. Tutty, Langley (CA); Brad Klatt, Surrey (CA); Jake Soroka, Vancouver (CA)

Correspondence Address: OYEN, WIGGS, GREEN & MUTALA;480 - THE STATION, 601 WEST CORDOVA STREET, VANCOUVER, BC, V6B 1G1, CA

(73) Assignee: Tutty Enterprises, Inc., Langley (CA)

(21) Appl. No.: 10/920,216

(22) Filed: Aug. 18, 2004

Related U.S. Application Data
(60) Provisional application No. 60/495,887, filed on Aug. 19, 2003.

(51) Int. Cl. G06F 17/60

(52) U.S. Cl. 705/35

(57) ABSTRACT

A method of customizing and producing products and services is provided. One or more groups of end users are surveyed in relation to their preferences for particular aspects of products and/or services. The end user groups may be associated with one or more partner organizations. The end user groups and partner organizations are remunerated for providing the preference information. The remuneration for end user groups and partner organizations may come from revenue associated with advertising that is disseminated to end users. End user groups and partner organizations are then given the opportunity to invest in the production of the desired products/services and to participate in the profits associated with the sale of the desired products/services to the public. The method may be administered by a liaison entity.

### RELATED APPLICATIONS

This application claims the benefit of the filing date of U.S. provisional patent application Ser. No. 60/495,887, filed 19 Aug. 2003.

### TECHNICAL FIELD

The invention relates generally to methods for customizing and producing products and/or services.

### BACKGROUND

Most of today's media content providers expend significant resources to produce media content without knowing whether that content will be well received by the eventual consumer/end user. For example, movie production companies spend large amounts of money producing movies whose box office performance is unpredictable because of uncertainty in the desires of the movie viewing consumer. In some cases, movies that have a low production costs generate sizeable income streams. Conversely, on some occasions, movies with large production costs generate very little income.

Similar unpredictability of consumer desires plagues providers of other products and/or services. An example of a service providing organization is a casino operator, which may invest heavily in the overhead required to provide its casino services. Such overhead may include building and decorating the casino, providing gambling services and providing food and beverage services. A casino operator may invest in all of this overhead only to subsequently determine that the casino's decor, food and beverage services and/or gambling services are failing to entice consumers to play at the casino. An example of a product providing organization is a video game developer, which may invest heavily in the overhead associated with the development of a video game. Such overhead may include the salaries of software engineers who are coding the game, for example. There is considerable uncertainty associated with consumer desire for video games and, in some circumstances, the video game may not be sufficiently popular with consumers to allow the video game developer to generate a profit on the sale of the video game product.

Today's predictive marketing strategies for products and/or services typically involve attempting to predict future consumer demand on the basis of past consumer behavior. Such predictive marketing techniques have proven to be less accurate than desired.

There is a need for methods for customizing and producing products and/or services that ameliorate or overcome some of the disadvantages associated with current techniques.

### SUMMARY OF THE INVENTION

This invention provides methods for customizing and producing products and/or services.

A first aspect of the invention provides a method for customizing a product/service. The method involves identifying one or more groups of end users, wherein each group of end users comprises a plurality of individuals. The method also involves obtaining preference information from each group of end users. Preference information preferably comprises information relating to one or more selection criteria about potential products/services to be produced. A desired product/service to be produced is then determined based at least in part on the preference information. Each group of end users is financially remunerated by conferring remuneration funds to the group. A first investment in production of the desired product/service is procured from each group of end users. The first investment from each group of end users preferably comprises at least a portion of the remuneration funds conferred to each group of end users.

Financially remunerating each group of end users may involve soliciting advertising material from advertisers, disseminating the advertising material to the individuals in each group of end users, collecting advertising revenue from the advertisers and conferring at least a portion of the advertising revenue to each group of end users or relating to individuals within each group of end users. Soliciting advertising material from advertisers may involve providing the advertisers with marketing information relating to each group of end users. Conferring at least a portion of the advertising revenue to each group of end users may involve conferring a fixed percentage of the advertising revenue to each group of end users.

The method may involve producing and selling the desired product/service to yield sales revenue and distributing at least a portion of the sales revenue to each group of end users.

At least one group of end users may belong to a partner organization. The method may comprise financially remunerating the partner organization by conferring at least a portion of the advertising revenue to the partner organization. The method may also involve procuring a second investment in production of the desired product/service from the partner organization. The second investment may comprise at least a portion of the advertising revenue that is conferred to the partner organization. The method may involve producing and selling the desired product/service to yield sales revenue, distributing at least a first portion of the sales revenue to each group of end users and distributing at least a second portion of the sales revenue to the partner organization.

Obtaining preference information from each group of end users may involve providing a preference entry website onto which the individuals in each group of end users submit individual preference information. Providing the preference entry website may comprise allowing the individuals to download a file and enter the individual preference information into the file. Providing the preference entry website may comprise allowing the individuals to enter the individual preference information into a fillable portion of the preference entry website.

Obtaining preference information from each group of end users may involve providing the individuals in each group of end users with preference solicitation material, which allows the individuals in each group of end users to express individual preference information. The preference solicitation material may include a survey, such that obtaining preference information from each group of end users involves receiving completed surveys from the individuals in each group of end users. The preference solicitation material may comprise advertising material. The preference solicitation material may comprise one or more samples of the potential products/services to be produced.

Producing the desired product/service may comprise engaging a product/service providing organization to help produce the desired product/service. The method may involve procuring a second investment in production of the desired product/service from the product/service providing organization. The method may involve producing and selling the desired product/service to yield sales revenue, distributing at least a first portion of the sales revenue to each group of end users and distributing at least a second portion of the sales revenue to the product/service providing organization.

Conferring remuneration funds to each group of end users may comprise holding the remuneration funds in a trust for which the group of end users is a beneficiary. Procuring an investment from each group of end users may comprise procuring an investment from the trust for which the group of end users is a beneficiary.

Conferring remuneration funds to each group of end users may comprise holding the remuneration funds in a trust for which the individuals in each group of end users are beneficiaries. Procuring an investment from each group of end users may comprise procuring an investment from the trust for which the individuals in each group of end users are beneficiaries.

Conferring remuneration funds to each group of end users may comprise holding the remuneration funds in a corporation for which the individuals in each group of end users are shareholders. Procuring an investment from each group of end users may comprise procuring an investment from the corporation.

Conferring remuneration funds to each group of end users may comprise conferring remuneration funds to the individuals in each group of end users. Procuring an investment from each group of end users may comprise procuring an investment from the individuals in each group of end users.

Another aspect of the invention provides a method for customizing a product/service. The method comprises providing preference solicitation material to at least one group of end users. The preference solicitation material allows the end users in the at least one group to express preference information comprising their preferences in relation to one or more selection criteria. The method also comprises: obtaining the preference information from the end users; based at least in part on the preference information, determining a desired product/service to be produced; financially remunerating the at least one group of end users by conferring remuneration funds to the at least one group of end users; and procuring an investment in production of the desired product/service from the at least one group of end users. The method also involves: producing and selling the desired product/service to yield sales revenue; and distributing at least a portion of the sales revenue to the at least one group of end users. Preferably, the funds used for the investment comprise at least a portion of the remuneration funds.

Further aspects of the invention and features of specific embodiments of the invention are described below.

### BRIEF DESCRIPTION OF THE DRAWINGS

In drawings which illustrate non-limiting embodiments of the invention:

FIG. 1 is a block diagram illustrating the entities involved in a method for customizing and producing products and/or services in accordance with a particular embodiment of the invention;

FIG. 2 is a block diagram which schematically illustrates a method for customizing and producing products and/or services in accordance with a particular embodiment of the invention;

FIG. 3 is a block diagram which schematically illustrates a particular embodiment of a method for obtaining end user preference information in accordance with the method of FIG. 2;

FIG. 4 is a block diagram which schematically illustrates a particular embodiment of a method for soliciting investment from various entities involved in the method of FIG. 2; and

FIG. 5 is a block diagram which schematically illuminates a particular embodiment of a method for distributing profits to various entities involved in the method of FIG. 2.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

Aspects of the invention provide methods for customizing and producing products and/or services. A liaison entity preferably administers and oversees the methods of the invention. Groups of end users are surveyed about their preferences relating to one or more selection criteria associated with various aspects of products and/or services and are remunerated for providing their preferences. One or more end user groups may belong to a partner organization who may also be remunerated for providing access to the end users. Remuneration for the end user groups and partner organizations may come from advertising. End user groups and partner organizations are then given the opportunity to invest in the production of desired product(s)/service(s) and to participate in the profits when the desired product(s)/service(s) are sold to the public.

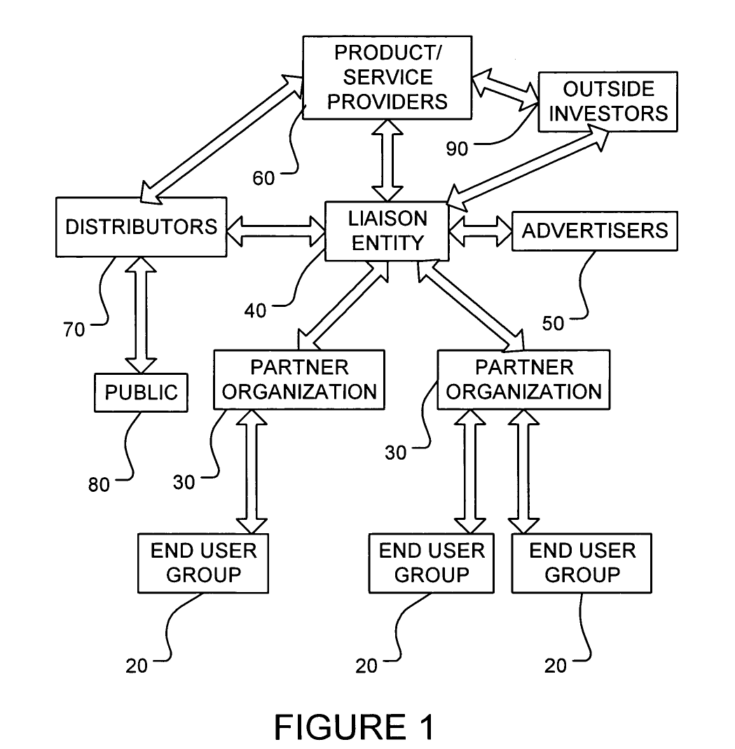

FIG. 1 is a block diagram illustrating the entities involved in a method for customizing and producing products and/or services in accordance with a particular embodiment of the invention. Liaison entity 40 is a coordinating entity which preferably oversees the methods of the invention. Liaison entity 40 may be a separate entity. However, in some embodiments, liaison entity 40 is not a separate entity, and may be an individual, group or sub-entity within any of the other entities shown in FIG. 1. For example, liaison entity 40 may be sub-entity within a product/service provider 60. Liaison entity 40 preferably has contractual or other similar business relationships with one or more partner organizations 30 and one or more advertisers 50. As will be explained further below, partner organizations 30 typically have a relationship with one or more end user groups 20. Preferably, each end user group 20 contains a relatively large number of individuals. Advertisers 50 may generally comprise any individual or organization that wants to promote their products or services to the individuals in end user groups 20. Liaison entity 40 may also have contractual or other similar business relationships with one or more product/service providers 60 and one or more distributors 70. In some embodiments of the invention, liaison entity 40 and/or product/service providers 60 may optionally procure investment from one or more outside investors 90. Liaison entity 40, end user groups 20, partner organizations 30, product/service providers 60 and any optional outside investors 90 may be referred to herein as “stakeholders”.

Partner organizations 30 are preferably organizations which are associated with or otherwise have access to one or more end user groups 20. Each end user group 20 preferably has a relatively large number of individuals. By way of non-limiting example, partner organizations 30 may include employer individuals or corporations, unions, religious groups, hobby associations, athletic organizations, student or faculty associations of academic institutions, professional organizations, charities or the like. As will be explained in greater detail below, partner organizations 30 provide liaison entity 40 with access to one or more end user groups 20 in return for remuneration. The individuals in end user groups 20 typically have some sort of relationship with their particular partner organization 30. For example, the individuals in end user groups 20 may be the employees of partner organization 30, the union members of partner organization 30, the parishioners of partner organization 30, the club members of partner organization 30 or the like. In some embodiments, liaison entity 40 may have direct access to individual end users (not shown) or to an end user group 20, in which case, the corresponding partner organization 30 may not be required.

In accordance with preferred embodiments of the invention, end user groups 20 are involved in customizing products and/or services by voting on various aspects of the products/services or by otherwise expressing their product/service preferences. In return for their participation in the customization of products/services, end user groups 20 are financially remunerated. As discussed in more detail below, such remuneration may be purely financial or may comprise additional or alternative non-monetary compensation techniques.

The financial remuneration provided to an end user group 20 may be held and/or administered collectively on behalf of an end user group 20. For example, funds received as remuneration for end user groups 20 may be held in a trust, in a corporation, in an investment fund or the like and may be administered for the collective benefit of the individuals in an end user group 20. In some embodiments, funds may be held in trust by a partner organization 30, by liaison entity 40, or by another suitable trustee and may be administered for the collective benefit of the individuals in a corresponding end user group 20. The trusts referred to in this description need not be formal legal trusts and may comprise informal relationships. In some embodiments, an end user group 20 may incorporate in a form where the individual end users are shareholders and any funds received as remuneration may be held in the corporation for the collective benefit of the end user shareholders. In some other embodiments, an end user group 20 may hold its financial remuneration in an investment fund, similar to a mutual fund, and the individual users in end user group 20 may be unit holders in the fund. As with trusts, any investment funds referred to in this description need not require formal legal relationships. Trusts, corporations or funds which collectively hold and/or administer the funds of end user groups 20 may be optional to individual end users in groups 20 or may be part of a condition of membership in end user groups 20. In some embodiments, individual users in groups 20 will be directly and individually remunerated rather than the remuneration being held for their collective benefit.

As will be explained in further detail below, when partner organizations 30 and end users within groups 20 receive financial remuneration for participation in the customization of products/services, they may use this financial remuneration and/or other resources to invest in the production of desired products/services. This method of customization and production of products/services is advantageous because it involves eventual consumers (i.e. end users) in the customization of the products/services and provides an incentive to the end users to participate in the customization process, because the end users can subsequently invest in the actual production of the desired product/services that they helped to customize.

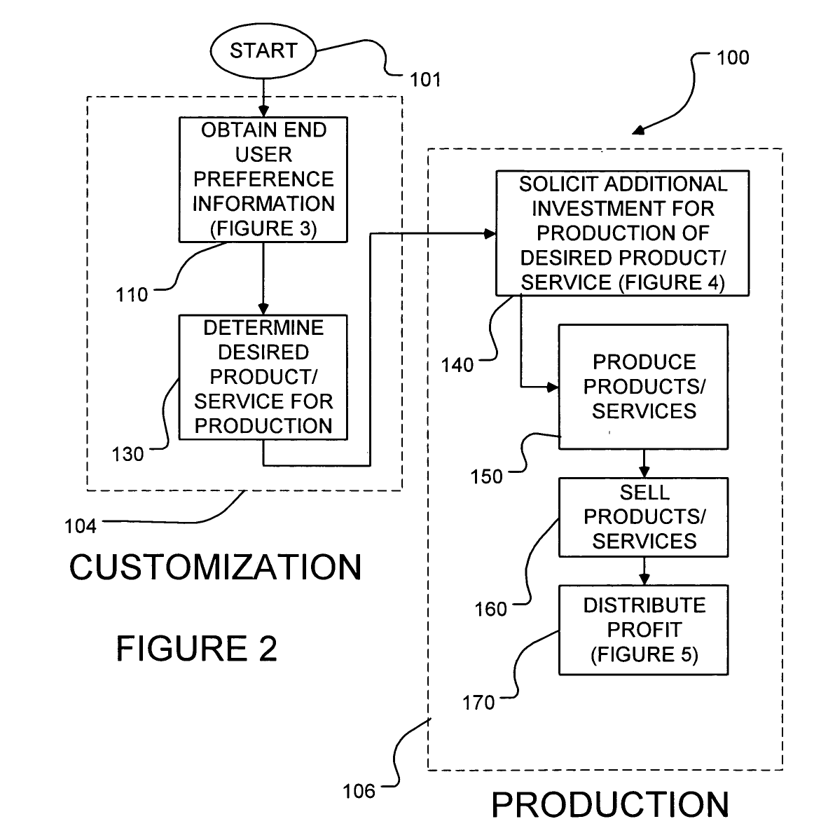

FIG. 2 is a schematic block diagram illustrating an example method 100 for customizing and producing products/services in accordance with a particular embodiment of the invention. Customization and production method 100 can be notionally divided into customization portion 104 and production portion 106. Those skilled in the art will appreciate, however, that various aspects of customization portion 104 may be performed during production portion 106 and various aspects of production portion 106 may be performed during customization portion 104. Accordingly, the division of method 100 into customization portion 104 and production portion 106 should be understood to be a notional division for the purposes of explanation only and not in a limiting sense.

To assist with the explanation of certain aspects of method 100, an example application of method 100 is used in parts of this description. In the example application of method 100, it is assumed that: (i) the product being customized and produced in method 100 is a movie; (ii) there is only one partner organization 30, which is a large corporation (“X Co.”) having 10,000 employees; and (iii) there is only one end user group 20 which is made up of the 10,000 employees of X Co. While using this example application of method 100 as a tool for explanatory purposes, those skilled in the art will appreciate that the methods described herein may be broadly applied to other products/services, other types of partner organizations 30, with other types of end user groups 20 and with pluralities of end user groups 20 and partner organizations 30.

The customization portion 104 of method 100 starts at block 101, where one or more end user groups 20 and possibly their one or more partner organizations 30 are identified to participate in method 100. It is possible to add additional partner organizations 30 and/or additional end user groups 20 during the course of customization and production method 100 (i.e. after block 101).

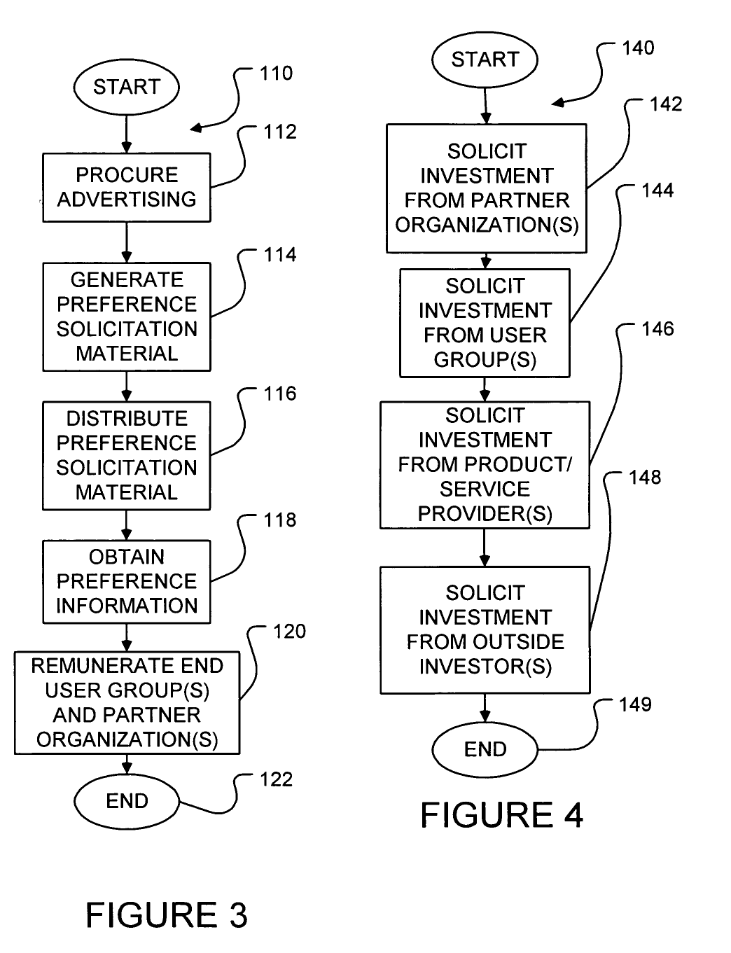

In block 110, liaison entity 40 obtains preference information from the individuals in end user groups 20. The preference information comprises one or more selection criteria relating to various aspects of the products and/or services to be produced by method 100. A particular embodiment of the block 110 process for obtaining preference information is illustrated in more detail in FIG. 3. In block 112, liaison entity 40 procures advertising from one or more advertisers 50 (FIG. 1). The advertising procured in block 112 will be disseminated to the individual end users in groups 20 (e.g. in the example application, to the 10,000 employees of X Co.). Advertisers 50 may generally include any individual or corporation that wants to pay liaison entity 40 to disseminate its advertising material to the end users in groups 20. Advertisers may specifically include product/service providers 60. The advertising material disseminated to the individual end users in groups 20 may take virtually any form. Examples of preferred techniques for disseminating advertising material to individuals in end user groups 20 are explained further below.

In preferred embodiments, at least some marketing information will be known about the individuals that make up end user groups 20 or about end user groups 20 generally. Such marketing information may attract certain advertisers 50. By way of non-limiting example, such marketing information may include demographic information, personal information, preference information from previous applications of method 100, or the like. In the example application of method 100, marketing information may include, for example, the fact that X Co. operates a group of hospitals and that the X Co. employees are largely female nurses in a certain age range and a certain income bracket, who live predominantly in neighborhoods adjacent to the hospitals.

Marketing information relating to end user groups 20 (or the individuals within groups 20) may be provided by the partner organizations 30 associated with end user groups 20 or by the individual end users themselves. The provision of marketing information may be a condition for the end user groups 20 to be remunerated for their participation method 100. Additionally or alternatively, individual end users in groups 20 may be asked to provide marketing information in a voluntary sign up and/or electronic registration process (not shown) at the outset of method 100. In some embodiments, individual end users in groups 20 may have provided marketing information while submitting their preference information in a previous application of method 100.

In some embodiments, partner organizations 30 may provide end user groups 20 with the opportunity to participate in method 100 (and to receive the corresponding remuneration) as a membership benefit, employment benefit or the like in return for the individuals in end user groups 20 consenting to partner organizations 30 providing marketing information to liaison entity 40 and/or advertisers 50. In the example application of method 100, X Co. may provide the opportunity of participating in method 100 (and receiving the associated remuneration) to its employees as a benefit in exchange for the employees allowing X Co. to provide liaison group 40 and advertisers 50 with marketing information about the employees. Those skilled in the art will appreciate that there are many techniques for acquiring marketing information relating to individuals in user groups 20 and/or to user groups 20 themselves. Preferably, such marketing information is available to liaison entity 40 and/or advertisers 50.

Advertisers 50 pay liaison entity 40 for the advertising disseminated to end user groups 20. This advertising revenue is used to remunerate partner organizations 30 and end user groups 20 in block 120 as explained further below.

In block 114, liaison entity 40 generates, assembles or otherwise procures preference solicitation material relating to the product/service being customized and produced by method 100. The preference solicitation material may take a wide variety of forms which may depend on the type of product/service being produced by method 100. By way of non-limiting example, the preference solicitation material may comprise sample versions of possible products/services about which end users can express their preferences, questionnaires or surveys relating to product/service preferences, sample advertisements relating to products/services about which end users can express their preferences or any combination of these types of materials. In general, the preference solicitation material may have any format, provided that it allows end users to express their preferences in relation to one or more selection criteria (i.e. preference information).

Preferably, the preference solicitation material is related to the product or service being customized and produced in method 100. In the example application, where the product being customized and produced in method 100 is a movie, the preference solicitation material may take the form of several short sample films coupled with a questionnaire having questions relating to the sample films and to a proposed full length movie product. The sample movies may comprise different plot lines, different special effects, different actors and/or different movie genres, for example. The accompanying questionnaire may ask the individual employees of X Co. to express their preferences as to a preferred one of the short movies, as to preferred aspects of different ones of the short movies or as to preferred aspects of how one or more of the short movies should be turned into full length movie products, for example. The accompanying questionnaire may also ask the employees of X Co. to vote on preferred characteristics of a proposed full length movie, such as who they would like to act in the movie, what genre of movie should be produced or what sort of budget should be spent to produce the movie, for example.

It is not generally necessary for liaison entity 40 to be the entity that actually generates the preference solicitation material in block 114. In some embodiments, liaison entity 40 may work with one or more product/service providers 60 to generate the preference solicitation material. In other embodiments, liaison entity 40 or product/service providers 60 will independently generate its own preference solicitation material. In still other embodiments, liaison entity 40 and/or product service providers 60 will outsource the generation of the preference solicitation material to a professional marketing organization (not shown).

In block 116, liaison entity 40 distributes the completed preference solicitation material to the end users in groups 20. There are many techniques for distributing the preference solicitation material to end users. For example, preference solicitation material may be distributed by broadcasting means, such as radio, conventional television, satellite television or digital cable television, by email or conventional mail, by electronic communication means, such as facsimile, by telephone, by distribution of digital or analog storage media or over the internet. Different portions of the preference solicitation material may be distributed by different means. Preference solicitation material may also be distributed by bringing the individuals in end user groups 20 together in one or more places to view or otherwise receive portions of the preference solicitation material.

In the example application, sample movies may be shown to employees of X Co. at a local theater. In some embodiments, preference solicitation material is distributed to individual end users in groups 20 by having the individual end users access the preference solicitation material from a website. Such a website may be operated by liaison entity 40. Preference solicitation material may additionally or alternatively be distributed by providing the preference solicitation material to partner organizations 30, who then distribute the preference solicitation material to the individuals within their corresponding end user groups 20. In the example application, liaison entity 40 may provide X Co. with 10,000 digital video discs (DVD's), each of which contains a number of sample movies. X Co. may then distribute the preference solicitation material DVD's to their employees along with their pay-checks or using some other distribution means.

Preferably, at least some of the advertising procured in block 112 is distributed to end user groups 20 together with the preference solicitation material. In general, the advertising material may comprise any individual one of (or any combination of): text-based advertising, audio-based advertising, image-based advertising, video-based advertising, multimedia advertising or the like. Preferably, but not necessarily, the advertising material is disseminated in such a manner that individual users in groups 20 are exposed to the advertising prior to or during their exposure to the preference solicitation material.

The specific nature and form of the advertising material may be dependent, in part, on the nature and form in which the preference solicitation material is distributed. If, for example, the preference solicitation material is distributed by broadcasting means or in the form of a data storage device (i.e. a DVD, for example), then the advertising material may comprise conventional audio, video or multimedia based advertising of the form commonly used in radio, television or on DVD. If the preference solicitation material is distributed by conventional mail, then the advertising material may take the form of flyers or circulars of the type commonly sent by mail or together with newspapers, for example. Additionally or alternatively, advertising material sent by mail may take the form of novelty items or multimedia advertising stored on digital or analog storage devices or the like, which may be sent directly to the end users. If the preference solicitation material is distributed by email, then the preference solicitation material may be coupled with digital advertising forms of the type commonly sent over email. If the preference solicitation material is accessed by end users 20 over the internet, then the website from which the end users 20 access the preference solicitation material may provide advertising material comprising pop-up advertising, banner advertising, or other forms of internet-based advertising, for example. The exemplary forms of advertising material discussed above represent non-limiting examples of the types of advertising material that may be provided with the preference solicitation material. In general, the invention should be understood to include advertising material of any nature and/or format.

In block 118, liaison entity 40 obtains end user preference information. End users in groups 20 express their preferences in response to the preference solicitation material provided to them in block 116. Preferably, the end users in groups 20 express their preferences by accessing and entering information on a preference entry website. The preference entry website may be operated by liaison entity 40. In some embodiments, a portion of the preference solicitation material is provided to the end users on the preference entry website. For example, the preference entry website may provide a number of downloadable audio samples and the end users may be requested to download the samples and answer preference related questions about the audio samples. The preference entry website may also comprise a downloadable or screen fillable questionnaire, survey or the like to be completed by the end users. End users may provide their preference information by entering their preferences in relation to the preference solicitation material available from the preference entry website and/or by entering their preferences in relation to earlier distributed preference solicitation material. The preference entry website may also require that the end users in groups 20 provide additional marketing information about themselves as a part of expressing their preferences.

Preferably, the preference entry website is capable of providing an account (e.g. a username and password) for each user in end user groups 20 (or, at least, for each end user group 20). The use of password protected accounts helps to ensure that liaison entity 40 does not obtain spurious preference information. Additional internet-based advertising material may be provided to end users via the preference entry website. Such advertising material may include banner advertisements, pop-up advertisements, and other internet-based advertisements, for example. Such advertising may provide e-commerce opportunities between advertisers 50 and the end users in groups 20, where individual end users can purchase the products/services of advertisers 50. Advertising on the preference entry website may generate additional advertising revenue which may be used to remunerate end user groups 20 or partner organizations 30 (see block 120 below).

In addition to submitting preference information at the preference entry website, end users may submit their preference information using alternative methods, such as by mailing their preference information to liaison entity 40 by conventional or electronic mail or by providing their preference information over the telephone, for example. End users who submit their preference information using alternative methods may complete a computer readable questionnaire, survey or the like. Such computer readable surveys or questionnaires may be provided to individual end users in any convenient manner, such as downloading from the internet, physical delivery or conventional mail, for example. Advertising material may be provided to the end users along with the surveys or questionnaires. End users who provide their preference information over the telephone may interact with an automated answering service which may receive preference information by recording tones, by recording the user's voice or by a combination thereof. The telephone service may be provided toll free to end users. Audio based advertising material may be distributed to end users using such a telephone service.

In block 120, liaison entity 40 remunerates partner organizations 30 and end user groups 20 for their participation in the customization portion 104 of method 100. Preferably, the remuneration of partner organizations 30 and end user groups 20 is administered by liaison entity 40. As discussed briefly above, the primary revenue source for remuneration of partner organizations 30 and end user groups 20 comes from advertising revenues obtained by liaison entity 40 from advertisers 50 in block 112. The advertising revenue used to remunerate end user groups 20 and partner organizations 30 may be gross advertising revenue or may be net of expenses associated with procuring advertising in block 112. Advertising revenue that is not used to remunerate end user groups 20 or partner organizations 30 may be retained by liaison entity 40.

In general, the specific remuneration for partner organizations 30 and end user groups 20 may accord with virtually any scheme. For example, partner organizations 30 and/or end user groups 20 may receive a fixed percentage of the advertising revenue or may receive a portion of the advertising revenue that depends on the number of end users in groups 20 who actually participate in the provision of preference information (i.e. the number of end users from whom preference information is obtained in block 118). The remuneration schemes for sharing advertising revenue among liaison entity 40, partner organizations 30 and end user groups 20 may also vary depending on whether there are any other additional or alternative compensation schemes for partner organizations 30 or end user groups 20.

As discussed below, user groups 20 and/or partner organizations 30 may be additionally or alternatively compensated by allowing them to invest during the production portion 106 of method 100 and by allowing them to share in a portion of any profits derived from sales of the products/services produced by method 100. However, some additional or alternative compensation schemes for end users in groups 20 do not involve participation in the production portion 106 of method 100. End users in groups 20 may receive additional or alternative compensation in the form of free or discounted promotional goods and services. For example, end users in groups 20 may be given free or discounted products provided by any of the entities involved in method 100 or coupons for free or discounted services provided by any of the entities involved in method 100.

In some embodiments, individuals in end user groups 20 may be additionally or alternatively compensated by giving them advance access to the products/services that are produced by method 100 or an opportunity to purchase the products/services that are produced by method 100 at discounted prices. For example, where the product being produced in method 100 is a movie or the like, end users in groups 20 may be additionally or alternatively compensated by giving them discounted tickets to view the movie when it is released or by giving them an opportunity to view the movie before it is released to the general public 80. As an additional example, where the service being produced in method 100 includes the gambling services provided by a casino or the like, end users in groups 20 may be given discounted chips to use in the casino, coupons for discounted food and beverage services at the casino, access to parts of the casino that are not available to the public 80 or access to parts of the casino prior to their availability to the public 80. As another further example, where the product being produced is a video game or the like, end user groups 20 may be additionally or alternatively compensated by giving them coupons to purchase the video game at a discount or by giving them an opportunity to purchase the video game prior to its release to the general public 80. Those skilled in the art will appreciate that the range of possible techniques for compensating individual users in groups 20 may vary widely depending on the end products/services produced by method 100 and that many other compensation techniques may be used in addition to or as alternatives to the examples described above.

After remunerating partner organizations 30 and end user groups 20 in block 120, the process for obtaining user preference information (block 110 of FIG. 2) comes to an end in block 122. Those skilled in the art will appreciate that the illustrated embodiment for obtaining user preference information (FIG. 3) is schematically depicted as having a number of blocks, but that the blocks need not be executed in sequential order or in the particular order depicted in FIG. 3. For example, remuneration of end user groups 20 and partner organizations 30 (block 120) may occur simultaneously with (or prior to) the time that liaison entity 40 obtains preference information (block 118) or simultaneously with (or prior to) the time that liaison entity 40 distributes the preference solicitation material (block 116). In another example, the generation of preference solicitation material (block 114) may have already been completed prior to procuring advertising (block 112).

Referring back to FIG. 2, the preference information obtained in block 110 is used in block 130 to make decisions about the product(s)/service(s) which are produced in the production portion 106 of method 100. The decisions made in block 130 may be made by liaison entity 40 and/or by one or more product/service providers 60 using the preference information obtained in block 110. In some embodiments, partner organizations 30 and/or end user groups 20 may also be directly involved in the block 130 determination of the product(s)/service(s) to produce. In particular, partner organizations 30 or end user groups 20 may be given an opportunity for further input in the block 130 determination in situations where they are investing in the production portion 106 of method 100, as explained further below.

For ease of explanation, the product(s)/service(s) determined in block 130 are referred to hereinbelow as the “desired” product(s)/service(s). In the schematically illustrated embodiment of FIG. 2, the determination of the desired product/service in block 130 marks the end of the customization portion 104 of method 100. However, those skilled in art will appreciate that the production of some types of desired products/services involves many decisions. As such, customization decisions similar to the types of decisions made in block 130 may also be made throughout the production portion 106 of method 100. Preferably, customization decisions made throughout the production portion 106 of method 100 are also made with recourse to the end user preference information determined in block 110.

The production portion 106 of customization and production method 100 commences in block 140 where liaison entity 40 optionally solicits additional investment for the production of the desired product/service. As discussed above, liaison entity 40 has derived some revenue from the sale of advertising to advertisers 50. Typically, liaison entity 40 will be left with a portion of this advertising revenue that is not used to remunerate end user groups 20 and partner organizations 30. In some applications of method 100, liaison entity 40 will not have sufficient resources to independently produce the desired product/service. In such applications, liaison entity 40 solicits additional investment from other sources in block 140. Those skilled in the art will appreciate that block 140 is optional in circumstances where liaison entity 40 is financially capable of producing the desired product/service without additional investment.

A particular embodiment of block 140 is shown in more detail in FIG. 4. In block 142 of the illustrated embodiment, liaison entity 40 solicits investment into the production of the desired product/service from partner organizations 30. Preferably, but not necessarily, the partner organizations 30 from which investment is solicited are the same partner organizations 30 that participated in the customization portion 104 of method 100. In preferred embodiments, partner organizations 30 will opt to invest some or all of the financial remuneration that they have received (in block 120) during the customization portion 104 of method 100. However, partner organizations 30 may generally invest using any resources that they have at their disposal.

Partner organizations 30 may invest in the production of the desired product/service through traditional investment vehicles, such as by conventional credit or equity participation. In other cases, partner organizations 30 invest through a contractual relationship with liaison entity 40 (and/or other entities involved in method 100) that provides for participation by the partner organizations 30 in a portion of the profits derived from sales of the desired product/service to the general public 80. In still other cases, partner organizations 30 and liaison entity 40 (and possibly other entities involved in method 100) will form a new business organization for the purposes of facilitating investment in the production of the desired product/service. Such business organizations may include, for example: partnerships, limited partnerships, corporations, joint ventures or the like.

In some cases, the investment of partner organizations 30 need not be monetary, as some partner organizations 30 will be able to provide other valuable resources or services. In the example application of method 100, the desired movie selected during the customization portion 106 of method 100 may involve one or more scenes that take place in a hospital, for example. Since X Co. runs hospitals, it may be able to invest in the production of the desired movie by contributing a service, such as the use of a portion of one of its hospitals for filming. Those skilled in the art will appreciate that, as used in this description, the words “invest”, “investing” and “investment” should be understood to include any type of contribution of value towards the production of the desired product/service in the production portion 106 of method 100. In general, there is no limitation on the types of investment that partner organizations 30 are capable of making in the production of the desired product/service.

Partner organizations 30 may be interested in investing in the production of the desired product/service, because partner organizations 30 know that their associated end user groups 20 were involved in the customization of the desired product/service. This knowledge may inspire partner organizations 30 to invest in the production of the desired product/service, because partner organizations 30 believe in the marketing research conducted in the customization portion 104 of method 100. In the example application of method 100, X Co. may be aware that its employees expressed preferences for a particular genre of movie having a particular lead actor. X Co. may then decide to invest in the production of such a movie, because X Co. believes that the preferences of its employees are representative of the preferences of the general public 80 and that, therefore, investment in the production of such a movie will produce a sizeable return.

Partner organizations 30 may additionally or alternatively be inspired to invest in the production of the desired product/service because they want to show support for their associated end user groups 20, who were involved in the customization of the desired product/service. In the example application of method 100, X Co. may want to show support for their employees and if their employees have participated in the customization portion 104 of method 100 and expressed preferences in a particular genre of movie having a particular lead actor, then X Co. may invest in the production of the movie as a means of maintaining good relations (or improving relations) with its employees.

In block 144 of the illustrated embodiment, liaison entity 40 solicits investment in the production of the desired product/service from end user groups 20. Preferably, but not necessarily, the end user groups 20 from which investment is solicited are the same end user groups 20 that participated in the customization portion 104 of method 100. In preferred embodiments, end user groups 20 invest some or all of the financial remuneration that they have received (in block 120) during the customization portion 104 of method 100. However, end user groups 20 may generally invest using any other contribution of value towards the production of the desired product/service. As with investment by partner organizations 30, end user groups 20 may invest in the production of the desired product/service through conventional credit or equity participation, through a contractual relationship which promises end user group 20 a portion of the profits associated with the sale of the desired product/service to the general public 80, through the creation of a new business organization with liaison entity 40 (and possibly other investors) and/or through the provision of non-monetary investment. In general, there is no limitation on the types of investment that end user groups 20 are capable of making in the production of the desired product/service.

As discussed above, the remuneration provided to end user groups 20 for participation in the customization portion 104 of method 100 may be held in a trust, a corporation, an investment fund or the like and administered for the collective benefit of the individuals in end user groups 20. In some embodiments, if the resources are held collectively by or for end user groups 20, then they may be invested collectively. Individuals in an end user group 20 may vote on whether their collective resources should be invested in the production of the desired product/service. In alternative embodiments, individual end users in groups 20 may opt to be paid out without investing or may individually invest their portion of the financial remuneration which their end user group 20 received (in block 120). The pay out to non-investing end users may be monetary or non-monetary. In embodiments where individual end users may elect not to invest, an end user group 20 that invests in the production of the desired product/service may comprise different individual members than when the same user group 20 participated in the customization portion 104 of method 100.

End user groups 20 may be interested in investing in the production of the desired product/service, because they know that the desired product/service is based on their preferences and/or because they believe in the marketing research conducted in the customization portion 104 of method 100. In the example application of method 100, the employees of X Co. may decide to invest in the production of the desired movie, because the X Co. employees believe that their preferences are representative of the preferences of the general public 80 and that, therefore, investment in the production of such a movie will produce a sizeable return.

Preferably, but not necessarily, the investment by end user groups 20 and partner organizations 30 in the production of the desired product/service is achieved through liaison entity 40. As discussed below, end user groups 20 and partner organizations 30 may invest through conventional credit or equity, through contractual means or through the establishment of a new business organizations. It is preferable, but not necessary, that the investments by partner organizations 30 and end user groups 20 are controlled by liaison entity 40 (or by a new business organization that is controlled by liaison entity 40). This arrangement may be more attractive to other potential investors, such as product/service providers 60 and/or outside investors 90, who may be uncomfortable with taking on partner organizations 30 and/or end user groups 20 as investment partners.

In block 146 of the illustrated embodiment, liaison entity 40 solicits investment from product/service providers 60. Preferably, but not necessarily, liaison entity 40 solicits investment from product/service providers 60 who are specialized in producing the desired product/service. For example, where the desired product/service is a movie, liaison entity 40 preferably solicits investment from product/service provider(s) 60 who are movie producing organization(s). As an alternative example, where the desired service includes gambling and the associated services involved in operating a casino, liaison entity 40 preferably solicits investment from product/service provider(s) 60 who are experienced with casino operation and/or casino building. As a further alternative example, where the desired product is a video game, liaison entity 40 preferably solicits investment from product/service provider(s) 60 who are video game producing organization(s). Product/service providers 60 may be interested in investing in the production of the desired product/service, because product/service providers 60 believe in the marketing research conducted in the customization portion 104 of method 100 and that the corresponding production of the desired product/service in the production portion 106 of method 100 will generate a profit.

Product/service providers 60 may invest in the production of the desired product/service using financial resources that they have at their disposal. Investment by product/service providers 60 in the production of the desired product/service may involve conventional credit or equity participation. Preferably, however, product/service providers 60 also invest by actively participating in the production of the desired product/service. Investment through active participation may involve a product/service provider 60 using its particular production expertise and/or its particular production resources to participate in the production of the desired product/service. Such active investment by product/service providers 60 may involve contractual or similar business relationships between product/service providers 60, liaison entity 40 and any other investing entities. Active investment by product/services providers 60 may also involve the formation of new business organizations which are made up of product/service providers 60, liaison entity 40 and possibly any other investing entities. New business organizations involving product/service providers 60 may involve any of the different types of new business organizations discussed above.

In the example application of method 100, the product/service provider 60 may be a movie production studio and the movie production studio may invest in the production of the desired movie by undertaking a joint venture with liaison entity 40 to produce the desired movie. As a part of such a joint venture, the movie production studio may provide some financial contribution, movie production staff, movie production equipment and/or other movie making expertise and resources and liaison entity 40 may provide some financial contribution together with its knowledge of the desired movie which it obtained from the customization portion 104 of method 100.

Soliciting investment from product/service providers 60 in block 146 may generally be performed at any time prior to or during customization and production method 100. Liaison entity 40 may form contractual or similar business relationships with one or more product/service providers 60 prior to the outset of method 100 or liaison entity 40 and product/service providers 60 may form any of the business organizations discussed above prior to the outset of method 100, so that product/service providers 60 and liaison entity 40 can work together to customize and produce a particular product/service in accordance with method 100. In the example application, liaison entity 40 may form a contractual relationship with a movie production studio prior to commencing customization and production method 100 or at any time during method 100. As a part of this contractual relationship, liaison entity 40 may agree to obtain the preference information of end user groups 20 in the customization portion 104 of method 100 and to provide this information to the movie production studio and the movie production studio may agree to produce the desired movie in the production portion 106 of method 100. In some embodiments, product/service provider 60 may control the production of the desired product/service (block 150 of FIG. 2) and the role of liaison entity 40 (and other investing entities) may be that of silent investor(s) during this part of method 100.

As with end user groups 20 and partner organizations 30, product/service providers 60 may generally invest using any contribution of value towards the production of the desired product/service and there is no limitation on the types of investment that product/service providers 60 are capable of making in the production of the desired product/service.

In block 148, investment in the production of the desired product/service may optionally be solicited from other outside investment sources 90. Such outside investors 90 may include traditional investment institutions, such as banks, venture capitalists, investment companies and the like. Investment from outside investors 90 preferably involves traditional credit or equity participation. Investment from outside investors 90 may also involve one or more contractual relationships with product/service providers 60, liaison entity 40 and/or with any of the other investing entities. Investment from outside investors 90 may also involve outside investors 90 and product/service providers 60, liaison entity 40 and/or any of the other investing entities creating of any of the new business organizations discussed above. Preferably, although not necessarily, outside investors 90 are not involved in the day to day decisions regarding the production of the desired product/service (block 150 of FIG. 2).

The process for soliciting additional investment for production of the desired product/service (block 140 of FIG. 2) comes to an end in block 149 (FIG. 3). Those skilled in the art will appreciate that the illustrated embodiment of the process for soliciting additional investment (FIG. 4) is schematically depicted as having a number of blocks, but that the blocks need not be executed in sequential order or in the particular order depicted in FIG. 4 and that any of blocks 140-149 may be omitted during a particular application of method 100. For example, as discussed above, soliciting investment from product/service providers 60 (block 146) may occur at any time prior to or during customization and production method 100. As another example, soliciting investment from partner organizations 30 (block 142) and/or from end user groups 20 (block 144) may occur simultaneously and may occur during the customization portion 104 of method 100. As yet another example, soliciting investment from outside investors 90 (block 148) may not be required.

Referring back to FIG. 2, the desired product/service is produced in block 150. In preferred embodiments, the production of the desired product/service is performed by one or more product/service providers 60 in possible conjunction with liaison entity 40. In other embodiments, the production of the desired product/service in block 150 is performed by liaison entity 40 without participation from external product/service provider(s) 60. For example, liaison entity 40 may produce the desired product/service without product/service providers 60 in circumstances where liaison entity 40 has sufficient funding and/or where liaison entity 40 possesses the expertise to produce the desired product/service without requiring assistance from external product/service providers 60.

The preference information obtained in the customization portion 104 of method 100 is preferably used in the production of the desired product/service in block 150. The preference information may be used to specify various technical, functional, aesthetic and/or any other aspects of the desired product/service produced in block 150. Similarly, where decisions must be made during the production of the desired product/service in block 150, then such decisions are preferably made with reference to the preference information obtained in the customization portion 104 of method 100.

For example, where the desired product is a movie and the preference information obtained in customization portion 104 of method 100 indicates a preference for a particular actor, the production of the desired movie in block 150 may involve the pursuit of that particular actor to appear in the movie. As an alternative example, where the desired service is a casino operation and the preference information obtained in customization portion 104 of method 110 indicates that end users prefer certain types of gambling services and/or certain types of food and beverage services, then the production of the desired services in block 150 will involve designing a casino to provide the desired types of gambling and food and beverage services. As a further alternative example, where the desired product is a video game and the preference information obtained in customization portion 104 of method 100 indicates that end users in groups 20 prefer a sports-based video game over an adventure-based video game, then the production of the desired product in block 150 may involve developing and producing a sports-based video game.

After production in block 150, the desired product/service is sold to the public 80 in block 160. Liaison entity 40 and/or product/service providers 60 may engage distributors 70 to assist with the sale of the desired product/service to the public 80 (FIG. 1). Alternatively, liaison entity 40 and/or product/service providers 60 may sell the desired product/service directly to the public 80. The preference information obtained from end user groups 20 in the customization portion 104 of method 100 may be representative of the preferences of the public 80. Consequently, it is predicted that the appetite of the public 80 for the desired product/service will be sizeable and that the desired product/service will produce substantial sales revenue when sold to the public 80. The sales of the desired product/service in block 160 may generally be accomplished by any sales technique, including any sales techniques in use today and developed in the future for comparable products/services.

Profits derived from the sales of the desired product/service in block 160 may be distributed in block 170 to any of the stakeholders who invested in the production of the desired product/services (i.e. outside investors 90, liaison entity 40, product/service providers 60, partner organizations 30 and/or end user groups 20). The distribution of profits in block 170 preferably (but not necessarily) occurs after expenses associated with customization and production method 100 have been subtracted from the sales revenue derived in block 160. For example, it is preferable that expenses associated with producing the desired product/service in block 150 and commissions or other expenses associated with the use of distributors 70 in block 160 be paid out of the sales revenues, prior to the distribution thereof in block 170.

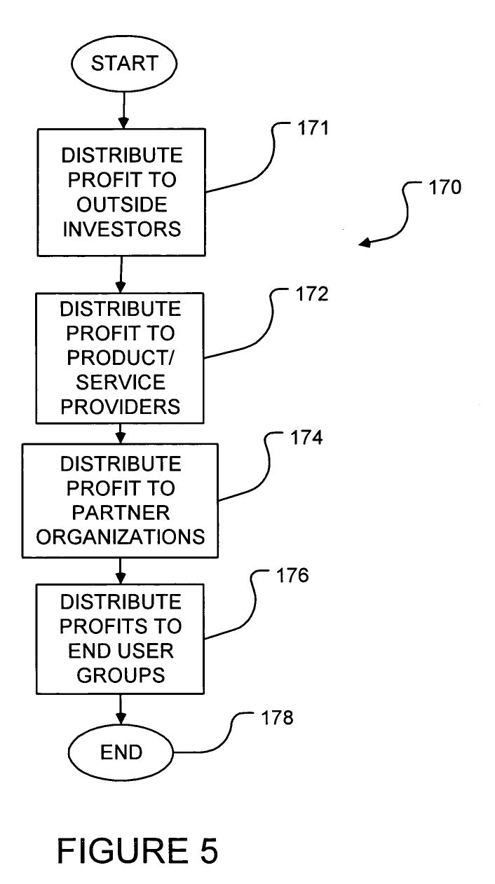

A particular embodiment of a method for the block 170 distribution of profits to the investing stakeholders is illustrated in greater detail in FIG. 5. In block 171, profits are distributed to the outside investors 90 who invested in the production of the desired product/service (see block 148 of FIG. 4). Preferably, but not necessarily, the distribution of profits to outside investors 90 in block 171 occurs before distribution of profits to other investing entities. In block 172, profits are distributed to the product/service providers 60 who invested in the production of the desired product/service (see block 146 of FIG. 4). In block 174, profits are distributed to the partner organizations 30 who invested in the production of the desired product/service (see block 142 of FIG. 4). In block 176, profits are distributed to the end user groups 20 who invested in the production of the desired product/service (see block 144 of FIG. 4).

Those skilled in the art will appreciate that the blocks depicted in FIG. 5 need not be executed in sequential order or in the particular order depicted in FIG. 5. For example, profit may be distributed to investing end user groups (block 176) prior to or simultaneous with distribution of profits to product/service providers (block 172). Furthermore, those skilled in the art will appreciate that any of blocks 171-178 may be omitted during a particular application of method 100.

The nature of the profit distribution in blocks 171, 172, 174, 176 may take a wide variety of forms depending on the nature of the investment provided by outside investors 90, product/service providers 60, partner organizations 30 and end user groups 20, the contractual and/or business relationships under which those investments were provided and the business organizations which are used to effect the production of the desired product/service.

In general, profits may be distributed by any means that is agreeable to the investing stakeholders. There are no specific limitations on the way that profits may be distributed to the investing stakeholders in block 170. Obviously, it is preferable that the agreement between the investing stakeholders be reached prior to sale of the desired product/service in block 160. This agreement may be handled by way of a contract to which each of the investing stakeholders is a party, by way of a contract between each of the investing stakeholders and liaison entity 40 or by way of a suitable business structure. As discussed above, in preferred embodiments, partner organizations 30 and end user groups 20 invest in the production of the desired product/service through liaison entity 40. Thus, partner organizations 30 and end user groups 20 may have separate contractual relationships with liaison entity 40 which govern how profits are distributed to partner organizations 30 in block 174 and to end user groups 20 in block 176.

In circumstances where the investing stakeholders invest in the production of the desired product/service using conventional investment vehicles (such as credit or equity vehicles), then the distribution of profits in blocks 170, 171, 172, 174, 176 may be made by conventional mechanisms for return on such investment vehicles. In these and other circumstances, the distribution of profits in blocks 170, 171, 172, 174, 176 need not strictly be a distribution of profits, but may comprise a different mechanism for providing investing stakeholders with a return on their investment. For example, where an outside investor 90 is a simple creditor, then the outside investor 90 may receive interest payments on its loan in block 171. Such interest payments may be calculated in a conventional manner and need not be related to profits made from sales of the desired product/service. In general, the distribution of profits in blocks 170, 171, 172, 174, 176 should be understood to include any mechanism for providing investing stakeholders with a return on investment whether or not the mechanism is related to the actual profit.

In some embodiments, the distribution of profits in blocks 170, 171, 172, 174, 176 may occur in accordance with a percentage based on the amount of investment by each of the investing stakeholders. In cases where investment is non-monetary, a valuation of the amount of investment may be made by a third party or agreed upon by the parties. For example, if a user group 20 invests $10,000, a partner organization 30 invests $10,000, a liaison entity 40 invests $80,000, a product/service provider 60 invests services and cash valued at a total of $400,000 and there are no outside investors 90, then user group 20 and partner organization 30 may each receive 2% of the profits, liaison entity 40 may receive 16% of the profits and product/service provider 60 may receive 80% of the profits.

In another non-limiting example, the distribution of profits in blocks 170, 171, 172, 174, 176 may occur in accordance with certain fixed percentages for certain investing stakeholders. For example, partner organizations 30 and end user groups 20 may each receive 5% of the total profits and then liaison entity 40, product/service providers 60 and outside investors 90 may share in the remaining profits in accordance with some other scheme. The fixed percentage received by partner organizations 30 and end user groups 20 may be related to the rate at which partner organizations 30 and end user groups 20 are remunerated (block 120) for their participation in the customization portion 104 of method 100. The fixed percentage provided to end user groups 20 and/or partner organizations 30 may be used to help obtain their participation in the customization portion 104 of method 100.

In another non-limiting example, one or more of the investing stakeholders may be offered a premium profit distribution. Such a premium profit distribution may arise because one of the investing stakeholders has invested more than the other investing stakeholders. For example, in the scenario described above, where a user group 20 invests $10,000, a partner organization 30 invests $10,000, a liaison entity 40 invests $80,000, a product/service provider 60 invests services and cash valued at a total of $400,000 and there are no outside investors 90, then product/service provider 60 may be paid a premium (e.g. 90% of the profits) because of the size of its investment relative to that of the other investing stakeholders. The other investing stakeholders may then share in the remaining profits in accordance with some other scheme.

In general, profits may be distributed to investing stakeholders in blocks 170, 171, 172, 174, 176 in accordance with any lawful scheme. Preferably, such schemes may be designed to minimize taxation. For example, where the profits are accumulated in a corporation, then the profits may be paid out as dividends, by the sale of shares or assets of the corporation, by the creation of subsidiary corporations or the like. In general, the exact nature of the scheme by which profits are distributed depends on the nature of the business organizations which are used to effect the production of the desired product/service. In general, this invention is independent of the specific scheme by which profits are distributed and there is no limitation on the scheme by which profits are distributed.

As will be apparent to those skilled in the art in the light of the foregoing disclosure, many alterations and modifications are possible in the practice of this invention without departing from the spirit or scope thereof. For example:
In some embodiments of the invention, a plurality of products/services may be simultaneously customized by generating (block 114) and distributing (block 116) preference solicitation material for a number of potential products and/or services. In such embodiments, preference information may be obtained for all of the potential products and/or services at the same time as part of block 118.
In some applications, the preference entry website may comprise additional functionality. For example, the preference entry website may comprise an internet search engine or other internet tools. An internet search engine or other internet tool(s) may cause individual users in end user groups 20 to spend more time on and/or return more frequently to the preference entry website and related websites, which may correspondingly increase advertising revenue and/or the marketability of advertising sold by liaison entity 40. Increased advertising may mean more income for liaison entity 40 and possibly increased remuneration for end user groups 20 and partner organizations 30.
In the embodiments described above, liaison entity 40 is described as being an independent entity. In alternative embodiments, liaison entity 40 may be a subsidiary, a subdivision, a marketing group or the like of another entity. For example, liaison entity 40 may be a subsidiary, a subdivision, a marketing group of a particular product/service providing organization 60. In some embodiments, liaison entity 40 may form a new entity or business organization with one or more other entities during the course of method 100. For example, liaison entity 40 and one or more product/service providers 60 may form a new corporate entity to perform some or all of method 100.
In some embodiments of method 100, distributors 70 and/or advertisers 50 are also given an opportunity to invest in the production portion 106 of method 100. In such embodiments, investment may be solicited from distributors 70 and/or advertisers 50 in block 140 and the distribution of profits to investing stakeholders in block 170 may comprise distribution of profits to investing distributors 70 and/or investing advertisers 50. As with other investing entities, there is no limit on the type of investment which may be provided by distributors 70 and/or advertisers 50.
In some embodiments of method 100, the block 170 distribution to one or more of the investing stakeholders may be made out of gross revenues rather than out of profits. For example, liaison entity 40 may agree with a product/service provider 60 to distribute a certain percentage of gross revenues to the product/service provider 60.
Investment in the production of the desired product/service by any of the investing entities, including liaison entity 40, end user groups 20, partner organizations 30, product/service providers 60 and outside investors 90, may involve the formation of new business organizations as discussed above. The participation of any particular one or more of these investing entities in any aspect of method 100 described above or recited in the claims hereof should be understood to include participation in the aspect of method 100 by any newly formed business organization which includes the one or more particular entities. For example, the above description sets out an investment technique whereby an outside investor 90 may invest in the production of the desired product/service through a contractual relationship with liaison entity 40. Such an investment technique should be understood to include a contractual relationship between any newly formed business organization which includes the outside investor 90 and any newly formed business organization which includes liaison entity 40.
   Accordingly, the scope of the invention is to be construed in accordance with the substance defined by the following claims.

1. A method for customizing a product, the method comprising:
identifying one or more groups of end users, each group of end users comprising a plurality of individuals;
obtaining preference information from each group of end users, the preference information comprising information relating to one or more selection criteria about potential products to be produced;
based at least in part on the preference information, determining a desired product to be produced;
financially remunerating each group of end users by conferring remuneration funds to each group of end users; and
procuring a first investment in production of the desired product from each group of end users;
wherein the first investment from each group of end users comprises at least a portion of the remuneration funds conferred to each group of end users.

2. A method according to claim 1 wherein financially remunerating each group of end users comprises:
soliciting advertising material from advertisers;
disseminating the advertising material to the individuals in each group of end users;
collecting advertising revenue from the advertisers; and
conferring at least a portion of the advertising revenue to each group of end users.

3. A method according to claim 2 wherein soliciting advertising material from advertisers comprises providing the advertisers with marketing information relating to each group of end users.

4. A method according to claim 2 wherein conferring at least a portion of the advertising revenue to each group of end users comprises conferring a fixed percentage of the advertising revenue to each group of end users.

5. A method according to claim 1 wherein at least one of the one or more groups of end users belongs to a partner organization and wherein the method further comprises financially remunerating the partner organization by conferring at least a portion of the advertising revenue to the partner organization.

6. A method according to claim 5 comprising procuring a second investment in production of the desired product from the partner organization, wherein the second investment comprises at least a portion of the advertising revenue that is conferred to the partner organization.

7. A method according to claim 1 wherein obtaining preference information from each group of end users comprises providing a preference entry website onto which the individuals in each group of end users submit individual preference information.

8. A method according to claim 7 wherein providing the preference entry website comprises allowing the individuals to download a file and enter the individual preference information into the file.

9. A method according to claim 7 wherein providing the preference entry website comprises allowing the individuals to enter the individual preference information into a fillable portion of the preference entry website.

10. A method according to claim 1 wherein obtaining preference information from each group of end users comprises providing the individuals in each group of end users with preference solicitation material, the preference solicitation material allowing the individuals in each group of end users to express individual preference information.

11. A method according to claim 10 wherein the preference solicitation material comprises a survey and wherein obtaining preference information from each group of end users comprises receiving completed surveys from the individuals in each group of end users.

12. A method according to claim 10 wherein the preference solicitation material comprises advertising material.

13. A method according to claim 10 wherein the preference solicitation material comprises one or more samples of the potential products to be produced.

14. A method according to claim 1 wherein producing the desired product comprises engaging a product providing organization to help produce the desired product.

15. A method according to claim 14 comprising procuring a second investment in production of the desired product from the product providing organization.

16. A method according to claim 14 comprising producing and selling the desired product to yield sales revenue, distributing at least a first portion of the sales revenue to each group of end users and distributing at least a second portion of the sales revenue to the product providing organization.

17. A method according to claim 6 comprising producing and selling the desired product to yield sales revenue, distributing at least a first portion of the sales revenue to each group of end users and distributing at least a second portion of the sales revenue to the partner organization.

18. A method according to claim 1 comprising producing and selling the desired product to yield sales revenue and distributing at least a portion of the sales revenue to each group of end users.

19. A method according to claim 1 wherein conferring remuneration funds to each group of end users comprises holding the remuneration funds in a trust for which each group of end users is a beneficiary.

20. A method according to claim 1 wherein conferring remuneration funds to each group of end users comprises holding the remuneration funds in a trust for which the individuals in each group of end users are beneficiaries.

21. A method according to claim 1 wherein conferring remuneration funds to each group of end users comprises holding the remuneration funds in a corporation for which the individuals in each group of end users are shareholders.

22. A method for customizing a product, the method comprising:
providing preference solicitation material to at least one group of end users, the preference solicitation material allowing the end users in the at least one group to express preference information comprising their preferences in relation to one or more selection criteria;
obtaining the preference information from the end users and, based at least in part on the preference information, determining a desired product to be produced;
financially remunerating the at least one group of end users by conferring remuneration funds to the at least one group of end users;
procuring an investment in production of the desired product, from the at least one group of end users;
producing and selling the desired product to yield sales revenue; and
distributing at least a portion of the sales revenue to the at least one group of end users;
wherein funds used for the investment comprise at least a portion of the remuneration funds.

23. A method for customizing a service, the method comprising:
identifying one or more groups of end users, each group of end users comprising a plurality of individuals;
obtaining preference information from each group of end users, the preference information comprising information relating to one or more selection criteria about potential services to be produced;
based at least in part on the preference information, determining a desired service to be produced;
financially remunerating each group of end users by conferring remuneration funds to each group of end users; and
procuring a first investment in production of the desired service from each group of end users;
wherein the first investment from each group of end users comprises at least a portion of the remuneration funds conferred to the group of end users.

24. A method for customizing a service, the method comprising:
providing preference solicitation material to at least one group of end users, the preference solicitation material allowing the end users in the at least one group to express preference information comprising their preferences in relation to one or more selection criteria;
obtaining the preference information from the end users and, based at least in part on the preference information, determining a desired service to be produced;
financially remunerating the at least one group of end users by conferring remuneration funds to the at least one group of end users;
procuring an investment in production of the desired service from the at least one group of end users;
producing and selling the desired service to yield sales revenue; and
distributing at least a portion of the sales revenue to the at least one group of end users;
wherein funds used for the investment comprise at least a portion of the remuneration funds.
